(19) United States
(12) Patent Application Publication
(10) Pub. No.: US 2023/0028266 A1
(43) Pub. Date: Jan. 26, 2023

(54) PRODUCT RECOMMENDATION TO PROMOTE ASSET RECYCLING

(71) Applicant: Dell Products L.P., Round Rock, TX (US)

(72) Inventors: Bijan Mohanty, Austin, TX (US); Harish Mysore Jayaram, Cedar Park, TX (US); Hung Dinh, Austin, TX (US)

(73) Assignee: Dell Products L.P., Round Rock, TX (US)

(21) Appl. No.: 17/383,843

(22) Filed: Jul. 23, 2021

(51) Int. Cl. G06Q 10/00; G06N 20/20; G06N 3/04; G06Q 30/02

(52) U.S. Cl. CPC G06Q 10/30; G06N 20/20; G06N 3/04; G06Q 30/0206

(57) ABSTRACT

In one aspect, an example methodology implementing the disclosed techniques includes receiving a corpus of historical recycling settlement data regarding a plurality of recycled assets, the historical recycling settlement data including information pertaining to a recycling of each asset of the plurality of recycled assets, wherein the information pertaining to the recycling includes a recovery value of each recycled asset. The method also includes generating a training dataset from the corpus of historical recycling settlement data, the training dataset including a plurality of training samples, each training sample of the plurality of training samples corresponding to a recycled asset, and training a recovery value prediction module using the plurality of training samples. Once trained, the recovery value prediction module can predict a recovery value of a provided asset.

### BACKGROUND

With the increasing awareness of environmental concerns, enterprises are becoming more aware of the carbon footprint and other environmental impacts of their products. For example, enterprises that manufacture and/or sell electronic devices, such as computers, mobile phones, storage devices, and peripheral devices, have manufactured billions of such devices for both personal and business uses. The number of new products being manufactured and sold is expected to only increase with the continued rapid pace at which these products evolve. For example, as a result of the rapid pace of development, older products are expected to be replaced with newer products having the latest features and technology. The rapid pace of development also contributes to these products continuing to be an increasingly indispensable part of modern life, thus resulting in a further increase in demand for new products.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a computer implemented method to predict a recovery value of an asset includes receiving a corpus of historical recycling settlement data regarding a plurality of recycled assets, the historical recycling settlement data including information pertaining to a recycling of each asset of the plurality of recycled assets, wherein the information pertaining to the recycling includes a recovery value of each recycled asset. The method also includes generating a training dataset from the corpus of historical recycling settlement data, the training dataset including a plurality of training samples, each training sample of the plurality of training samples corresponding to a recycled asset, and training a recovery value prediction module using the plurality of training samples to predict a recovery value of a provided asset.

In some embodiments, a training sample corresponding to a recycled asset includes one or more features correlated with the recovery value of the recycled asset.

In some embodiments, the recovery value prediction module includes a regression-based model.

In one aspect, the regression-based model includes a gradient boosting regression model.

In one aspect, the regression-based model includes a dense neural network (DNN).

In some embodiments, the method further includes predicting, using a trained recovery value prediction module, a recovery value of an old asset, identifying, using a machine learning (ML) model, one or more new products that most closely match the old asset, and recommending the one or more new products with an offer to recycle the old asset for the predicted recovery value.

In some embodiments, the trained recovery value prediction module includes a k-nearest neighbor (k-NN) model.

In some embodiments, the one or more new products are identified using one of Euclidean distance or cosine similarity.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to receive a corpus of historical recycling settlement data regarding a plurality of recycled assets, the historical recycling settlement data including information pertaining to a recycling of each asset of the plurality of recycled assets, wherein the information pertaining to the recycling includes a recovery value of each recycled asset. Execution of the instructions also causes the one or more processors to generate a training dataset from the corpus of historical recycling settlement data, the training dataset including a plurality of training samples, each training sample of the plurality of training samples corresponding to a recycled asset. Execution of the instructions further causes the one or more processors to train a recovery value prediction module using the plurality of training samples to predict a recovery value of a provided asset.

In some embodiments, a training sample corresponding to a recycled asset includes one or more features correlated with the recovery value of the recycled asset.

In some embodiments, the recovery value prediction module includes a regression-based model.

In one aspect, the regression-based model includes a gradient boosting regression model.

In one aspect, the regression-based model includes a dense neural network (DNN).

In some embodiments, execution of the instructions further causes the one or more processors to predict, using a trained recovery value prediction module, a recovery value of an old asset, identify, using a machine learning (ML) model, one or more new products that most closely match the old asset, and recommend the one or more new products with an offer to recycle the old asset for the predicted recovery value.

In some embodiments, the trained recovery value prediction module includes a k-nearest neighbor (k-NN) model.

In some embodiments, the one or more new products are identified using one of Euclidean distance or cosine similarity.

According to another illustrative embodiment provided to illustrate the broader concepts described herein, a computer implemented to offer recovery of an old asset includes determining, using a first machine learning (ML) model, a predicted recovery value for an old asset, identifying, using a second ML model, one or more new products that most closely match the old asset, and recommending the one or more new products with an offer to recycle the old asset for the predicted recovery value.

In some embodiments, the first ML model is trained using a training dataset generated from historical recycling settlement data regarding a plurality of recycled assets.

In some embodiments, the first ML model includes a regression-based model.

In some embodiments, the second ML model is trained using a training dataset generated from information regarding configuration and pricing of a plurality of new products.

In some embodiments, the second ML model includes a k-nearest neighbor model.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to determine, using a first machine learning (ML) model, a predicted recovery value for an old asset, identify, using a second ML model, one or more new products that most closely match the old asset, and recommend the one or more new products with an offer to recycle the old asset for the predicted recovery value.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative system architecture including a product recommendation system, in accordance with an embodiment of the present disclosure.

FIG. 2 is a diagram showing an illustrative data structure that represents a training dataset for training a learning model to predict a recovery value of an old asset, in accordance with an embodiment of the present disclosure.

FIG. 3 is a diagram showing an illustrative data structure that represents a training dataset for training a learning model to predict which new product(s) most closely match an old asset, in accordance with an embodiment of the present disclosure.

FIG. 4 is a diagram illustrating an example architecture of a dense neural network (DNN) model of a recovery value prediction module of FIG. 1, in accordance with an embodiment of the present disclosure.

FIG. 5 is a diagram showing an example recovery value prediction topology that can be used to predict a recovery value for an asset, in accordance with an embodiment of the present disclosure.

FIG. 6 is a diagram showing an example product recommendation topology that can be used to recommend new products to replace an old asset, in accordance with an embodiment of the present disclosure.

FIG. 7 is a flow diagram of an example process for recommending one or more products, in accordance with an embodiment of the present disclosure.

FIG. 8 is a block diagram illustrating selective components of an example computing device in which various aspects of the disclosure may be implemented, in accordance with an embodiment of the present disclosure.

### DETAILED DESCRIPTION

As noted above, consumer demand for new products is only expected to increase and enterprises that manufacture and/or sell these products are expected to meet the increasing demand for their products. A primary challenge is what to do with the older products that are being replaced by the new products as improper disposal of these products can cause harm to the environment. One solution is for an enterprise that sells products to work with one or more eco-partners to offer an asset recovery and recycle program where consumers can recycle old assets (e.g., used products) and recover some of the asset recovery value (the left-over value of the old asset). For example, under the asset recovery and recycle program, a consumer can recycle their old asset (e.g., trade-in their used asset) when placing an order for a new product offered by the enterprise. When fulfilling the order for the new product, the enterprise informs an appropriate one of its eco-partners of the location of the old asset, which allows the eco-partner to pick-up and recycle the old asset. After the old asset is recycled, the eco-partner sends the recovery value of the old asset (e.g., the components' left-over value) along with settlement data (e.g., document detailing the specifics regarding the recycling of the old asset(s)) to the enterprise. The enterprise can then pay a portion (e.g., 80%, 85%, 90%, etc.) of the received recovery value to the consumer. Thus, in addition to being environmentally responsible, recovery value compensation can be a major driver/motivator for recycling old assets for both the enterprise and the consumer. However, since the actual recovery value of an old asset is known only after the old asset is recycled, payment to the consumer occurs after the consumer commits to the purchase of and pays for the new product. Not knowing the recovery value of the old asset at the time of purchasing a new product may deter the consumer from making the purchase and/or recycling their old asset. Although the enterprise can commit to a ballpark value for the old asset at the time of purchase of a new product, this creates unwanted uncertainty and risk to the enterprise as the quoted ballpark value can vary drastically from the actual recovery value of the old asset. In cases where the actual recovery value is significantly larger than the quoted value, there is also the risk of creating a disgruntled consumer.

It is appreciated herein that historical asset recovery value data is a very good indicator for accurately estimating a recovery value for an old asset (e.g., an old product). Thus, certain embodiments of the concepts, techniques, and structures disclosed herein are directed to estimating a recovery value of an old asset based on historical asset recovery value data. In some embodiments, a learning model (e.g., a regression-based deep learning model) may be trained using machine learning techniques (including neural networks) to predict a recovery value of an asset (e.g., old asset). For example, to train the model, historical asset recovery value data (e.g., information regarding recycled assets and the recovery values of individual the recycled assets) can be collected. Once this data is collected, the variables or parameters (also called features) that are correlated to or influence (or contribute to) the recovery value for a recycled asset can be determined (e.g., identified) from the corpus of historical asset recovery value data. These relevant features can then be used to generate a dataset (e.g., a training dataset) that can be used to train the model. A feature (also known as an independent variable in machine learning) is an attribute that is useful or meaningful to the problem that is being modeled (i.e., predicting a recovery value of an old asset). For example, in the case of electronic devices, the relevant features may include information regarding the recycled asset (i.e., the old asset), the vendor (e.g., eco-partner) who is performing the recycling, the customer who is recycling the asset, and the recovery value of the asset. Being able to accurately estimate a recovery value of an old asset allows enterprises to encourage their customers to recycle their old assets. The ability to accurately estimate recovery values of old assets enables an enterprise to encourage its customers to recycle their old assets since the enterprise can offer and commit to the estimated recovery values prior to the actual recycling of the old assets.

According to some embodiments disclosed herein, information regarding an old asset and it's predicted recovery value can be used to generate a new product recommendation to replace the old asset. In some embodiments, a learning model (e.g., a classification model) may be trained using machine learning techniques with new product configuration and pricing data. For example, the new product configuration and pricing data may be for the new products that are being sold by an enterprise. The collected data may be used to generate a dataset (e.g., a training dataset) that can be used to train the model. For example, the features that are relevant to the problem being modeled (i.e., predicting which new product(s) most closely match an old asset) can be identified from the new product configuration and pricing data and used to generate the training dataset for the model. For example, in the case of electronic devices, the relevant features may include information regarding a new product such as a product model, type of processor included in the product, type of operating system, size of a display screen, amount and configuration of the memory included in the product, size and type of hard disk drive included in the product, and the price of the product, among others. Once trained using the training dataset, the trained model can be used to determine, provided configuration information and recovery value of an old asset, one or more new products which most closely match the old asset. The one or more new products that most closely match the old asset can then be recommended as replacements for the old asset. This provides an enterprise a great opportunity to upsell by offering to take an old asset as a form of a trade-in and upgrade the old asset with a new product. For example, the enterprise can offer a discount on a new product and/or service which equals the estimated recovery value of an old asset an incentive for its customers to purchase the new product and/or service.

Although certain embodiments and/or examples are described herein in the context of electronic devices, it will be appreciated in light of this disclosure that such embodiments and/or examples are not restricted as such, but are applicable to any type of product that is manufactured and sold, in the general sense. Numerous variations and configurations will be apparent in light of this disclosure.

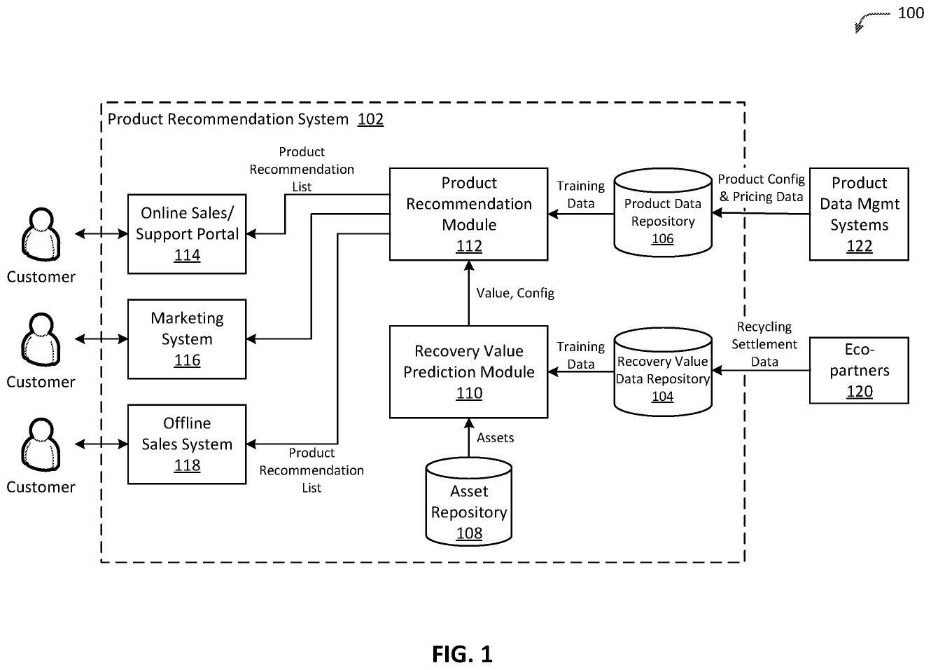

Referring now to the figures, FIG. 1 is a diagram of an illustrative system architecture 100 including a product recommendation system 102, in accordance with an embodiment of the present disclosure. An enterprise, for instance, may implement and use product recommendation system 102 to estimate recovery values of old assets of its customers. In some embodiments, the enterprise may also use product recommendation system 102 to identify and recommend new product(s) to its customers to replace their old assets. As shown, product recommendation system 102 includes a recovery value data repository 104, a product data repository 106, an asset repository 108, a recovery value prediction module 110, a product recommendation module 112, an online sales/support portal 114, a marketing system 116, and a sales system 118. Product recommendation system 102 can include various other hardware and software components which, for the sake of clarity, are not shown in FIG. 1.

The various components of architecture 100, including the components of product recommendation system 102, may be communicably coupled to one another via one or more networks (not shown). The network may correspond to one or more wired or wireless computer networks including, but not limited to, local area networks (LANs), wide area networks (WANs), personal area networks (PANs), metropolitan area networks (MANs), storage area networks (SANs), virtual private networks (VPNs), wireless local-area networks (WLAN), primary public networks, primary private networks, Wi-Fi (i.e., 802.11) networks, other types of networks, or some combination of the above.

Recovery value data repository 104 stores or otherwise records historical recycling settlement data. The historical recycling settlement data may include information regarding recycled assets and the recovery values of the individual recycled assets. For example, as can be seen in FIG. 1, the historical recycling settlement data may be collected or otherwise obtained from the enterprise's eco-partners 120. Eco-partners 120 perform the recovery and recycling of assets (e.g., old assets). Thus, in such embodiments, recovery value data repository 104 can be understood as a storage point for data that is collected from eco-partners 120 and that is used to generate a training dataset that can be used to train a model (e.g., recovery value prediction module 108) to predict a recovery value of an asset (e.g., old asset).

The historical recycling settlement data may be stored in a tabular format. In the table, the structured columns represent the features (also called variables) and each row represents an observation or instance (e.g., a recycled asset). Thus, each column in the table shows a different feature of the instance. In some embodiments, recovery value data repository 104 can perform preliminary operations with the collected historical recycled settlement data (i.e., information regarding recycled assets and the recovery values of the individual recycled assets) to generate the training dataset. For example, the preliminary operations may include null data handling (e.g., the handling of missing values in the table). According to one embodiment, null or missing values in a column (a feature) may be replaced by a mode or median value of the values in that column. According to alternative embodiments, observations (i.e., recycled assets) in the table with null or missing values in a column may be removed from the table.

The preliminary operations may also include feature selection and/or data engineering to determine (e.g., identify) the relevant features from the historical recycling settlement data. The relevant features are the features that are more correlated with the thing being predicted by the trained model (e.g., a recovery value of an old asset). A variety of feature engineering techniques, such as exploratory data analysis (EDA) and/or bivariate data analysis with pair plots and/or correlation diagrams, among others, may be used to determine the relevant features.

The preliminary operations may also include data preprocessing to place the data (information) in the table into a format that is suitable for training a model. For example, since machine learning deals with numerical values, textual categorical values (i.e., free text) in the columns (e.g., customer, vendor, manufacturer, model, grade, location, etc.) can be converted (i.e., encoded) into numerical values. According to one embodiment, the textual categorical values may be encoded using label encoding. According to alternative embodiments, the textual categorical values may be encoded using one-hot encoding.

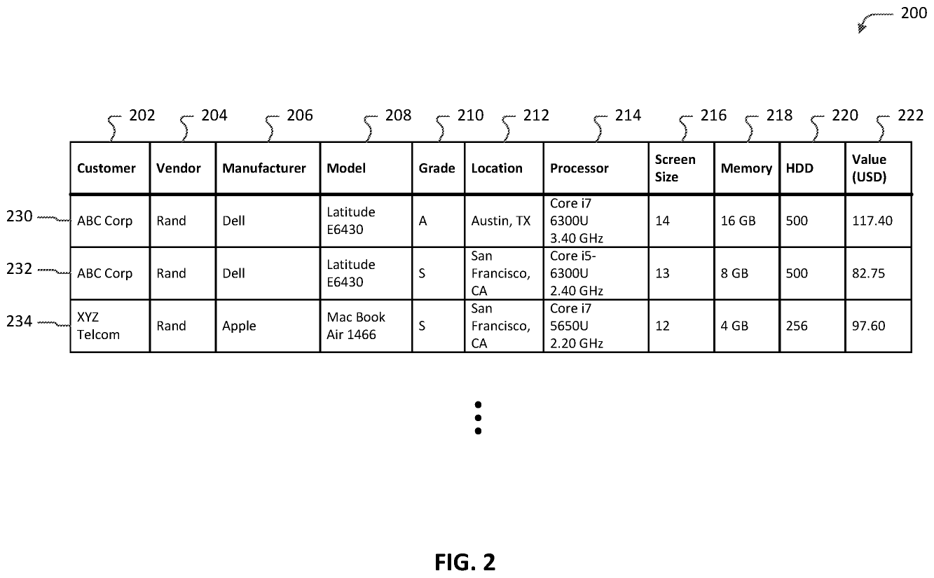

FIG. 2 is a diagram showing an illustrative data structure 200 that represents a training dataset for training a learning model to predict a recovery value of an old asset, in accordance with an embodiment of the present disclosure. More specifically, data structure 200 may be in a tabular format in which the structured columns represent the different relevant features (variables) regarding the recycled assets and a row represents each recycled asset. The relevant features illustrated in data structure 200 are merely examples of features that may be extracted from the historical recycling settlement data and used to generate a training dataset and should not be construed to limit the embodiments described herein.

As shown in FIG. 2, the relevant features may include a customer 202, a vendor 204, a manufacturer 206, a model 208, a grade 210, a location 212, a processor 214, a screen size 216, a memory 218, a HDD 220, and a value 222. Customer 202 indicates a customer who recycled the old asset. Vendor 204 indicates the eco-partner or other entity that performed the recycling of the old asset. Manufacturer 206 indicates the manufacturer or producer of the old asset. Model 208 indicates the model of the old asset. Grade 210 indicates the condition or quality of the old asset. Location 212 indicates the location at which the old asset was recycled. Processor 214 indicates the type of processor (e.g., central processing unit) that is included in the old asset. Screen size 216 indicates the size of a display screen that is included in the old asset. Memory 218 indicates the amount of memory that is included in the old asset. HDD 220 indicates the size of the hard disk drive that is included in the old asset. Value 220 indicates the recovery value of the old asset.

In data structure 200, each row may represent a training sample (i.e., an instance of a training sample) in the training dataset, and each column may show a different relevant feature of the training sample. Each training sample may correspond to an old asset that was recycled. As can be seen in FIG. 2, three training samples 230, 232, 234 are illustrated in data structure 200. In some embodiments, the individual training samples 230, 232, 234 may be used to generate a feature vector, which is a multi-dimensional vector of elements or components that represent the features in a training sample. In such embodiments, the generated feature vectors may be used for training a model to predict a recovery value of an asset (e.g., old asset). The features customer 202, vendor 204, manufacturer 206, model 208, grade 210, location 212, processor 214, screen size 216, memory 218, and HDD 220 may be included in a training sample as the independent variables, and the feature value 222 included as the dependent (or target) variable in the training sample. Note that the number of training samples depicted in data structure 200 is for illustration, and those skilled in the at will appreciate that the training dataset may, and likely will, include large and sometimes very large numbers of training samples.

Referring again to FIG. 1, product data repository 106 stores or otherwise records new product data. The new product data may include information regarding the enterprise's new products. For example, as can be seen in FIG. 1, the new product data may be collected or otherwise obtained from the enterprise's product data management systems 122. Product data management systems 122 provide management of the enterprise's new products, including new product configuration and pricing data. Thus, in such embodiments, product data repository 106 can be understood as a storage point for data that is collected from the enterprise's product data management systems 122 and that is used to generate a training dataset that can be used to train a model (e.g., product recommendation module 112) to predict which new product(s) most closely match an old asset.

The new product data may be stored in a tabular format. In the table, the structured columns represent the features (also called variables) and each row represents an observation or instance (e.g., a new product). Thus, each column in the table shows a different feature of the instance. In some embodiments, product data repository 106 can perform preliminary operations with the collected new product data (i.e., information regarding the enterprise's new products) to generate the training dataset. For example, similar to the preliminary operations with the collected historical recycled settlement data described above, the preliminary operations may include null data handling of missing values in the table, feature selection and/or data engineering to determine (e.g., identify) the relevant features from the new product data, and/or data preprocessing to place the data (information) in the table into a format that is suitable for training a model, as described above.

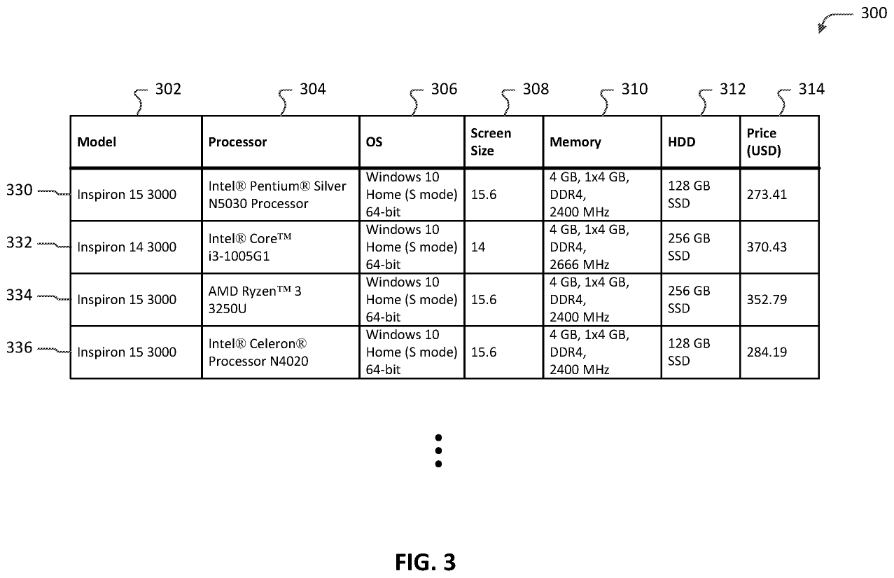

FIG. 3 is a diagram showing an illustrative data structure 300 that represents a training dataset for training a learning model to predict which new product(s) most closely match an old asset, in accordance with an embodiment of the present disclosure. Data structure 300 may be in a tabular format in which the structured columns represent the different relevant features (variables) regarding the enterprise's new products and a row represents each new product. The relevant features are the features that are more correlated with the thing being predicted by the trained model (e.g., predicting which new product(s) most closely match an old asset). The relevant features illustrated in data structure 300 are merely examples of features that may be extracted from the new product data and used to generate a training dataset and should not be construed to limit the embodiments described herein.

As shown in FIG. 3, the relevant features may include a model 302, a processor 304, an OS 306, a screen size 308, a memory 30, an HDD 312, and a price 314. Model 302 indicates a model of the new product. Processor 304 indicates the type of processor (e.g., central processing unit) that is included in the new product. OS 306 indicates the type of operating system that is include din the new product. Screen size 308 indicates the size of a display screen that is included in the new product. Memory 310 indicates the amount and configuration of the memory included in the new product. HDD 312 indicates the size and type of hard disk drive included in the new product. Price 314 indicates the price of the new product.

Similar to data structure 200 described above, in data structure 300, each row may represent a training sample (i.e., an instance of a training sample) in the training dataset, and each column may show a different relevant feature of the training sample. Each training sample may correspond to a new product that is being sold or otherwise provided by the enterprise. As can be seen in FIG. 3, four training samples 330, 332, 334, 336 are illustrated in data structure 300. In some embodiments, the individual training samples 330, 332, 334, 336 may be used to generate a feature vector, which is a multi-dimensional vector of elements or components that represent the features in a training sample. In such embodiments, the generated feature vectors may be used for training a model to predict new product(s) that most closely match an old asset. The features model 302, processor 304, OS 306, screen size 308, memory 30, and HDD 312 may be included in a training sample as the independent variables, and the feature price 314 included as the dependent (or target) variable in the training sample. Note that the number of training samples depicted in data structure 300 is for illustration, and those skilled in the at will appreciate that the training dataset may, and likely will, include large and sometimes very large numbers of training samples.

Asset repository 108 stores or otherwise records data associated with the assets (i.e., products) that were sold by the enterprise. This data may include information such as, for example, the customer to whom the asset was sold, the current owner of the asset, the configuration of the asset, the date the asset was sold/purchased, and other details regarding the asset and the sale/purchase of the asset. In some embodiments, product recommendation system 102 can leverage the data stored in asset repository 108 to identify assets that are candidates for asset recovery, thus allowing the enterprise to upsell.

For example, in one use case and embodiment, from the data stored in asset repository 108, the enterprise can identify assets (e.g., old assets) that are candidates for asset recovery (e.g., recycling). According to one embodiment, these assets may be identified based on an expected lifespan of the asset. For example, the assets that are within a predetermined threshold time of their expected lifespan or past their expected lifespan can be identified as candidates for asset recovery. According to alternative embodiments, a machine learning algorithm can be used to predict when assets are at the end of their life or within a threshold time of the end of their life. Once an old asset is identified as a candidate for asset recovery, the enterprise can determine the recovery value of the old asset and one or more new products that most closely match the old asset. The enterprise can then upsell a customer (e.g., current owner of the old asset) by offering to take the old asset from the customer as a form of a trade-in and upgrade the old asset with a new product(s) via multiple sales channels.

As shown in FIG. 1, one sales channel may be online sales/support portal 114 for facilitating online sales and/or support of the enterprise's products. For example, when a customer accesses or otherwise visits online sales/support portal 114, a notification of the recommended new product(s) to replace the customer's old asset (e.g., notification offering a discount on the new product(s) which equals the estimated recovery value of an old asset) can be displayed. Another example sales channel may be marketing system 116 for facilitating the marketing of the enterprise's products. For example, the enterprise's marketing unit can perform various marketing activities (e.g., traditional marketing, outbound marketing, inbound marketing, digital marketing, etc.) to promote the sale of new products and services with an offer to recover old assets at the estimated recovery values. Another example sales channel may be offline sales system 118 for facilitating offline sales of the enterprise's products. For example, the enterprise's sales unit can send notifications to customers regarding the offer to replace the customers' old assets with new products at a discount equaling the estimated recovery values of the old assets.

Referring still to FIG. 1, recovery value prediction module 110 can predict a recovery value of an asset (e.g., old asset) when provided details (information) regarding the asset. To this end, in some embodiments, recovery value prediction module 110 includes a learning model (e.g., a gradient boosting regression model) that is trained using machine learning techniques with a training dataset generated using historical asset recovery value data. In such embodiments, the training dataset may be provided by recovery value data repository 104. In some embodiments, a randomly selected portion of the training dataset can be used for training the gradient boosting regression model, and the remaining portion of the training dataset can be used as a testing dataset. In one embodiment, 70% of the training dataset can be used to train the model, and the remaining 30% can be used to form the testing dataset. The model can then be trained using the portion of the training dataset (i.e., 70% of the training dataset) designated for training the model. Once trained, the testing dataset can be applied to the trained model to evaluate the performance of the trained model. For example, the trained model can process the training dataset and a value of an appropriate performance metric (e.g., mean squared error) can be calculated and used to assess the performance of the trained model.

In some embodiments, recovery value prediction module 110 includes a deep learning model (e.g., a dense neural network (DNN)) that is trained using machine learning techniques with a training dataset generated using historical asset recovery value data. In such embodiments, the training dataset may be provided by recovery value data repository 104. As described previously, 70% of the training dataset can be used to train the DNN, and the remaining 30% can be used to form the testing dataset.

In brief, the DNN includes an input layer for all input variables such as customer, vendor, manufacturer, model, etc., multiple hidden layers for feature extraction, and an output layer. Each layer may be comprised of a number of nodes or units embodying an artificial neuron (or more simply a “neuron”). As a DNN, each neuron in a layer receives an input from all the neurons in the preceding layer. In other words, every neuron in each layer is connected to every neuron in the preceding layer and the succeeding layer. As a regression-based model (or more simply a “regressor”), output layer is comprised of a single neuron, which outputs a continuous, numerical value representing a recovery value of an asset.

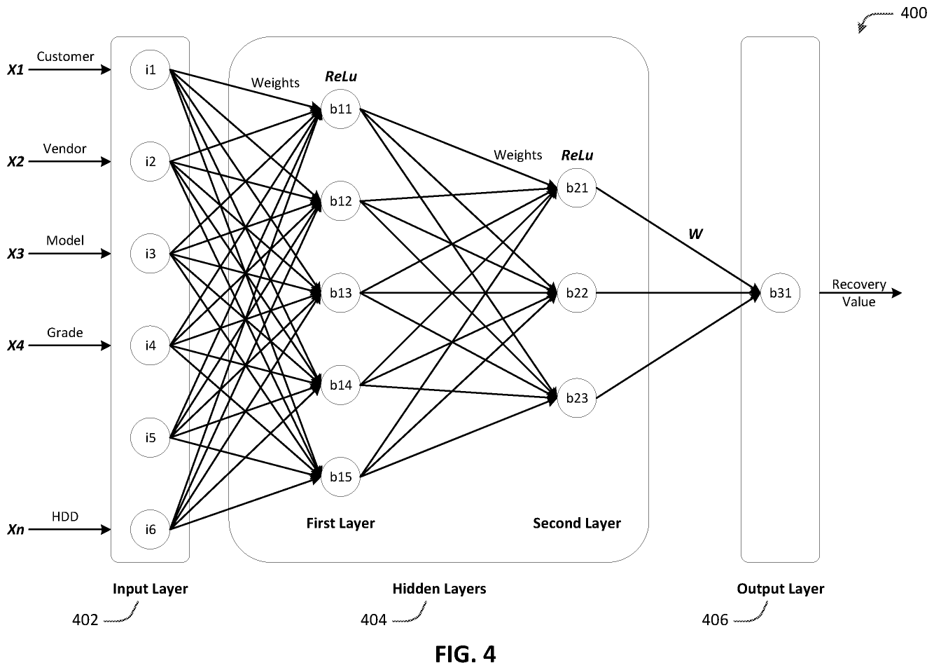

In more detail, and as shown in FIG. 4, a DNN 400 includes an input layer 402, multiple hidden layers 404 (e.g., two hidden layers), and an output layer 406. Input layer 402 may be comprised of a number of neurons to match (i.e., equal to) the number of input variables (independent variables). Taking as an example the independent variables illustrated in data structure 200 (FIG. 2), input layer 402 may include 10 neurons to match the 10 independent variables (e.g., customer 202, vendor 204, manufacturer 206, model 208, grade 210, location 212, processor 214, screen size 216, memory 218, and HDD 220), where each neuron in input layer 402 receives a respective independent variable. Each succeeding layer (e.g., a first layer and a second layer) in hidden layers 404 will further comprise an arbitrary number of neurons, which may depend on the number of neurons included in input layer 402. For example, according to one embodiment, the number of neurons in the first hidden layer may be determined using the relation 2ⁿ≥number of neurons in input layer, where n is the smallest integer value satisfying the relation. In other words, the number of neurons in the first layer of hidden layers 404 is the smallest power of 2 value equal to or greater than the number of neurons in input layer 402. For example, in the case where there are 19 input variables, input layer 402 will include 19 neurons. In this example case, the first layer can include 32 neurons (i.e., 2⁵=32). Each succeeding layer in hidden layers 404 may be determined by decrementing the exponent n by a value of one. For example, the second layer can include 16 neurons (i.e., 2⁴=16). In the case where there is another succeeding layer (e.g., a third layer) in hidden layers 404, the third layer can include 8 neurons (i.e., 2³=8). As a regressor, output layer 406 includes a single neuron.

Although FIG. 4 shows hidden layers 404 comprised of only two layers, it will be understood that hidden layers 404 may be comprised of a different number of hidden layers. Also, the number of neurons shown in the first layer and in the second layer of hidden layers 404 is for illustration only, and it will be understood that actual numbers of neurons in the first layer and in the second layer of hidden layers 404 may be based on the number of neurons in input layer 402.

According to one embodiment, hidden layers 404 is comprised of a first hidden layer having 16 neurons and a second hidden layer having 8 neurons. Each neuron in hidden layers 404 may be associated with an activation function. For example, according to one embodiment, the activation function may be a rectified linear activation function (ReLU). Since this is a dense network, as can be seen in FIG. 4, each neuron in the different layers may be coupled to one another. Each coupling (i.e., each interconnection) between two neurons may be associated with a weight, which may be learned during a learning or training phase. Each neuron may also be associated with a bias factor, which may also be learned during a training process. As DNN 400 is to function as a regressor, the neuron in output layer 406 is not associated with an activation function.

DNN 400 can be built by first creating a shell model and then adding desired number of individual layers to the shell model. For each layer, the number of neurons to include in the layer can be specified along with the type of activation function to use and any kernel parameter settings. Once DNN 400 is built, a loss function (e.g., mean squared error), an optimizer algorithm (e.g., a gradient-based optimization technique such as RMSprop), and validation metrics (e.g., mean squared error and/or mean absolute error) can be specified for training, validating, and testing DNN 400.

DNN 400 can then be trained by passing the portion of the training dataset (i.e., 70% of the training dataset) designated for training and specifying a number of epochs. An epoch (one pass of the entire training dataset) is completed once all the observations of the training data are passed through DNN 400. DNN 400 can be validated once DNN 400 completes the specified number of epochs. For example, DNN 400 can process the training dataset and the loss/error value can be calculated and used to assess the performance of DNN 400. The loss value indicates how well DNN 400 is trained. Note that a higher loss value means DNN 400 is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train DNN 400. In any case, once the loss is reduced to a very small number (ideally close to 0), DNN 400 is sufficiently trained for prediction.

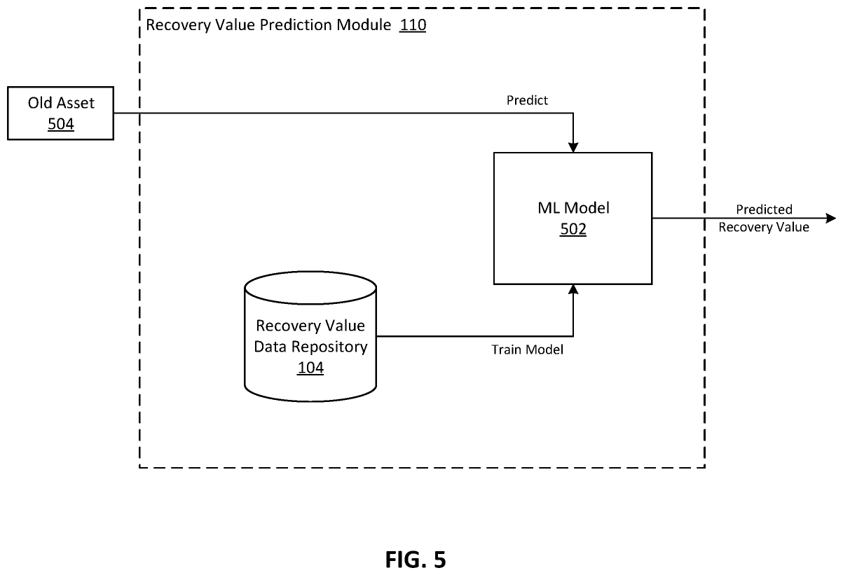

Once sufficiently trained, as illustrated in FIG. 5 in which like elements of FIG. 1 are shown using like reference designators, recovery value prediction module 110 can be used to predict a recovery value of an asset (e.g., old asset). As shown in FIG. 5, recovery value prediction module 110 includes a machine learning (ML) model 502. As described previously, according to one embodiment, ML model 502 can be a gradient boosting regression model. According to alternative embodiments, ML model 502 can be a DNN (e.g., DNN 400 of FIG. 4). In any case, ML model 502 can be trained and tested using machine learning techniques with a training dataset provided by recovery value data repository 104. The trained ML model 502 can then be used to predict a recovery value for an asset. For example, for an old asset 504 for which a recovery value is to be predicted, features from the old asset, such as customer, vendor, model, processor, etc., may be input, passed, or otherwise provided to the trained ML model 502 to predict a recovery value of old asset 504.

Referring again to FIG. 1, product recommendation module 112 can determine the new products that most closely match an asset (e.g., old asset) when provided details, such as configuration information and recovery value, regarding the asset. In other words, product recommendation module 112 can predict which new product(s) most closely match an asset. To this end, in some embodiments, product recommendation module 112 can leverage a learning model (e.g., k-nearest neighbor (k-NN) model) and a distance similarity measure algorithm (e.g., Euclidean distance or cosine similarity) to determine one or more new products that most closely match an asset. In such embodiments, the k-NN model can be trained using machine learning techniques with a training dataset generated using new product configuration and pricing data. For example, the training dataset may be provided by product data repository 106. The chosen distance similarity measure algorithm (e.g., Euclidean distance or cosine similarity) can be configured as a hyperparameter and passed to the k-NN model.

It is appreciated that k-NN is a non-parametric, lazy learning algorithm, meaning that the k-NN algorithm does not make any assumptions on the underlying data. The k-NN algorithm operates on the basic assumption that data points with similar classes are closer to each other. In other words, k-NN makes its selection based on the proximity to the other data points regardless of what feature the numerical values represent.

Euclidean distance (also known as 2-norm) is a straight-line distance between two vectors or datapoints (products). Unlike cosine similarity which uses the angle between two datapoints, Euclidean distance can be calculated by simply computing the square root of the sum of the squared differences between the two data points (vectors). The Euclidean distance algorithm may be expressed as follows:

Euclidean distance=\sqrt{Σᵢ^{N}(x1ᵢ−x2ᵢ)²},

where x1 is the first row of data, x2 is the second row of data, and i is the index to a specific column.

A smaller Euclidean distance value means that the two products are more similar. A zero Euclidean distance means that both products are the same with all matching attributes and configurations.

Cosine similarity is a measure of similarity between two non-zero vectors (in this case products) of an inner product space that measures the cosine of the angle between the two non-zero vectors. As such, cosine similarity is a judgment of orientation, and not magnitude. Two products with the same orientation will have 0 degrees between them and a cosine similarity of 1 (cos(0)=1). Two products that are completely different from each other (diametrically opposite) will have a magnitude of 180 degrees between them and a cosine similarity of −1 (cos(180)=−1). Two products that have a magnitude of 90 degrees will have cosine similarity of 1 (cos(90)=1).

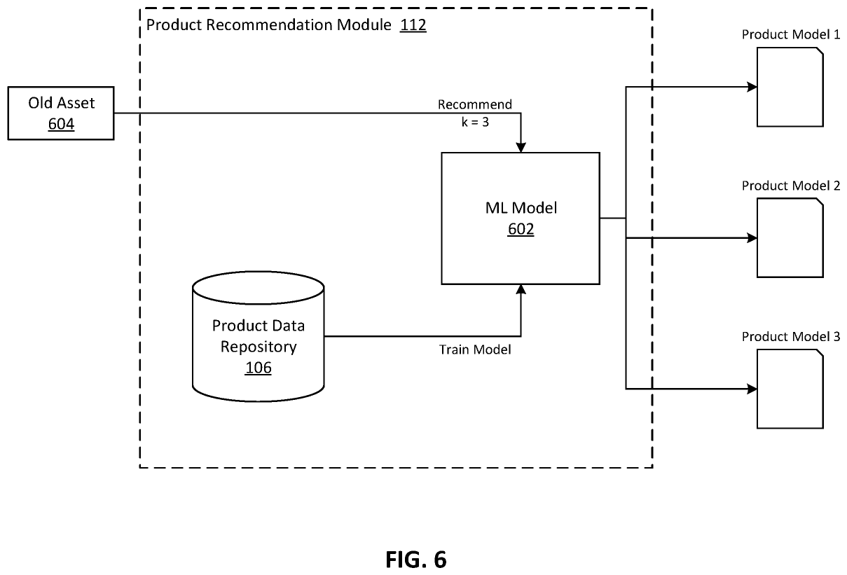

Once sufficiently trained, as illustrated in FIG. 6 in which like elements of FIG. 1 are shown using like reference designators, product recommendation module 112 can be used to determine one or more new products that most closely match an asset (e.g., old asset). As shown in FIG. 6, product recommendation module 112 includes a machine learning (ML) model 602. As described previously, according to one embodiment, ML model 602 can be a k-NN model. ML model 602 can be trained and tested using machine learning techniques with a training dataset provided by product data repository 106. The trained ML model 602 can then be used to determine, for an old asset 604 input, passed, or otherwise provided to the trained ML model 602 to be matched, the one or more new products in the training dataset that most closely match the provided asset. For example, for an old asset for which closely matching new products are to be determined, features from the old asset, such as model, processor, OS, screen size, memory, price, etc., may be input, fed, or otherwise provided to the trained ML model 602. The distance between the provided old asset and each new product included in the training dataset (i.e., each instance) can then be calculated. For example, as explained above, the distance can be calculated using Euclidean distance or cosine similarity. Once the distances are calculated, the trained ML model 602 can output the k new products (i.e., k instances) in the training dataset as the k new products that most closely match the old asset based on the calculated distances. For example, the k instances in the training dataset having the shortest distance to the asset can be determined to be the k new products that most closely match the old asset. For example, as shown in FIG. 6, based on a k value of 3, the trained ML model 602 can determine the three new products, Product Model 1, Product Model 2, and Product Model 3, which most closely match old asset 604.

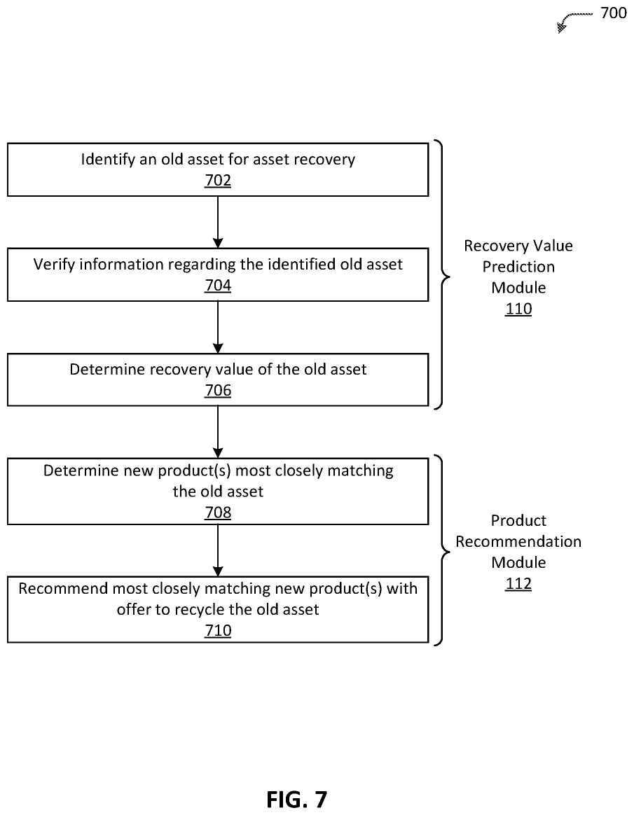

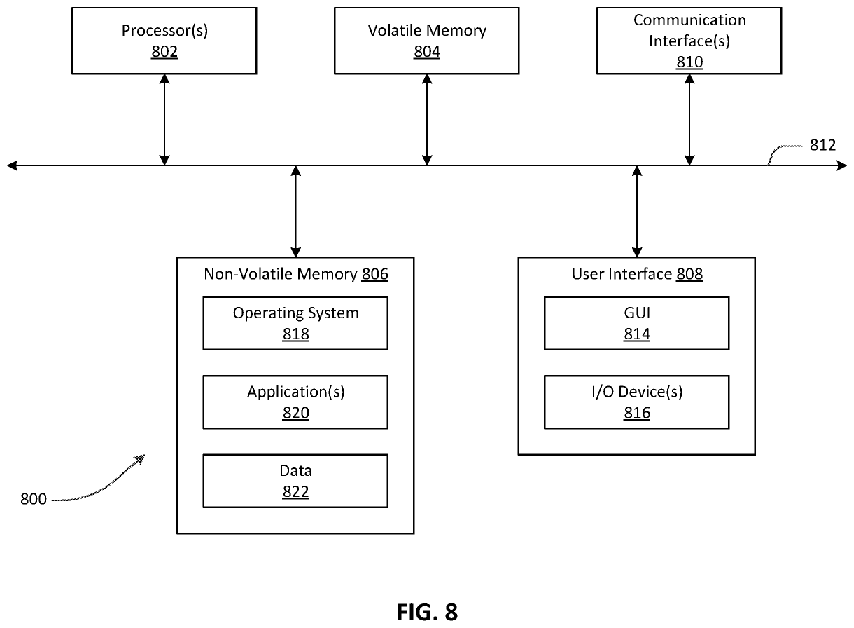

FIG. 7 is a flow diagram of an example process 700 for recommending one or more products, in accordance with an embodiment of the present disclosure. Process 700 may be implemented or performed by any suitable hardware, or combination of hardware and software, including without limitation the system shown and described with respect to FIG. 1, the computing device shown and described with respect to FIG. 8, or a combination thereof. For example, in some embodiments, the operations, functions, or actions illustrated in process 700 may be performed, for example, in whole or in part by recovery value prediction module 110 and product recommendation module 112, or any combination of these including other components of system 100 described with respect to FIG. 1.

With reference to process 700 of FIG. 7, and in an illustrative use case, at 702, recovery value prediction module 110 can identify an old asset as a candidate for asset recovery (e.g., recycling). In some embodiments, the old asset may be identified from the recorded data regarding the assets that were sold by an enterprise. In some embodiments, the old asset may be identified from information provided via one of the enterprise's sales channels (e.g., online sales/support portal 114, marketing system 116, or offline sales system 118). For example, a customer who purchased an asset from the enterprise may visit online sales/support portal 114 to search for information regarding the asset and, based on certain criteria, the customer's asset may be identified as an old asset that is a candidate for asset recovery.

At 704, recovery value prediction module 110 can verify the information regarding the identified old asset. For example, in cases where the old asset is identified based on information provided via one of the enterprise's sales channels, the provided information can be checked with the recorded data regarding the assets that were sold by an enterprise to verify that the identified old asset is an asset that was sold by the enterprise. In some cases, recovery value prediction module 110 can retrieve the asset configuration information (e.g., information regarding the configuration of the old asset) from asset repository 108.

At 706, recovery value prediction module 110 can determine a recovery value for the old asset. For example, according to one embodiment, the recovery value or the old asset can be determined based on a prediction of a recovery value output by a trained learning model (e.g., a trained gradient boosting regression model or a trained dense neural network (DNN)).

At 708, product recommendation module 112 can determine the new product(s) (e.g., one new product, two new products, three new products, or any suitable number of new products) that most closely match the old product. In some embodiments, the new product(s) that most closely match the old product can be based on the configuration information and predicted recovery value of the old asset.

At 710, product recommendation module 112 can recommend the most closely matching new product(s) (i.e., the new products that most closely match the old asset) with an offer to recycle the old asset. For example, the recommendation may be made to the current owner of the old asset. In this way, the enterprise can upsell a customer (e.g., current owner of the old asset) by offering to take the old asset from the customer as a form of a trade-in and upgrade the old asset with a new product(s) that closely matches the old asset.

FIG. 8 is a block diagram illustrating selective components of an example computing device 800 in which various aspects of the disclosure may be implemented, in accordance with an embodiment of the present disclosure. As shown, computing device 800 includes one or more processors 802, a volatile memory 804 (e.g., random access memory (RAM)), a non-volatile memory 806, a user interface (UI) 808, one or more communications interfaces 810, and a communications bus 812.

Non-volatile memory 806 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 808 may include a graphical user interface (GUI) 814 (e.g., a touchscreen, a display, etc.) and one or more input/output (I/O) devices 816 (e.g., a mouse, a keyboard, a microphone, one or more speakers, one or more cameras, one or more biometric scanners, one or more environmental sensors, and one or more accelerometers, etc.).

Non-volatile memory 806 stores an operating system 818, one or more applications 820, and data 822 such that, for example, computer instructions of operating system 818 and/or applications 820 are executed by processor(s) 802 out of volatile memory 804. In one example, computer instructions of operating system 818 and/or applications 820 are executed by processor(s) 802 out of volatile memory 804 to perform all or part of the processes described herein (e.g., processes illustrated and described in reference to FIGS. 1 through 7). In some embodiments, volatile memory 804 may include one or more types of RAM and/or a cache memory that may offer a faster response time than a main memory. Data may be entered using an input device of GUI 814 or received from I/O device(s) 816. Various elements of computing device 800 may communicate via communications bus 812.

The illustrated computing device 800 is shown merely as an illustrative client device or server and may be implemented by any computing or processing environment with any type of machine or set of machines that may have suitable hardware and/or software capable of operating as described herein.

Processor(s) 802 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 802 may be analog, digital or mixed signal. In some embodiments, processor 802 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 810 may include one or more interfaces to enable computing device 800 to access a computer network such as a Local Area Network (LAN), a Wide Area Network (WAN), a Personal Area Network (PAN), or the Internet through a variety of wired and/or wireless connections, including cellular connections.

In described embodiments, computing device 800 may execute an application on behalf of a user of a client device. For example, computing device 800 may execute one or more virtual machines managed by a hypervisor. Each virtual machine may provide an execution session within which applications execute on behalf of a user or a client device, such as a hosted desktop session. Computing device 800 may also execute a terminal services session to provide a hosted desktop environment. Computing device 800 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A computer implemented method to predict a recovery value of an asset, the method comprising:
receiving a corpus of historical recycling settlement data regarding a plurality of recycled assets, the historical recycling settlement data including information pertaining to a recycling of each asset of the plurality of recycled assets, wherein the information pertaining to the recycling includes a recovery value of each recycled asset;
generating a training dataset from the corpus of historical recycling settlement data, the training dataset including a plurality of training samples, each training sample of the plurality of training samples corresponding to a recycled asset; and
training a recovery value prediction module using the plurality of training samples to predict a recovery value of a provided asset.

2. The method of claim 1, wherein a training sample corresponding to a recycled asset includes one or more features correlated with the recovery value of the recycled asset.

3. The method of claim 1, wherein the recovery value prediction module includes a regression-based model.

4. The method of claim 3, wherein the regression-based model includes a gradient boosting regression model.

5. The method of claim 3, wherein the regression-based model includes a dense neural network (DNN).

6. The method of claim 1, further comprising:
predicting, using a trained recovery value prediction module, a recovery value of an old asset;
identifying, using a machine learning (ML) model, one or more new products that most closely match the old asset; and
recommending the one or more new products with an offer to recycle the old asset for the predicted recovery value.

7. The method of claim 6, wherein the trained recovery value prediction module includes a k-nearest neighbor (k-NN) model.

8. The method of claim 7, wherein the one or more new products are identified using one of Euclidean distance or cosine similarity.

9. A system comprising:
one or more non-transitory machine-readable mediums configured to store instructions; and
one or more processors configured to execute the instructions stored on the one or more non-transitory machine-readable mediums, wherein execution of the instructions causes the one or more processors to:
receive a corpus of historical recycling settlement data regarding a plurality of recycled assets, the historical recycling settlement data including information pertaining to a recycling of each asset of the plurality of recycled assets, wherein the information pertaining to the recycling includes a recovery value of each recycled asset;
generate a training dataset from the corpus of historical recycling settlement data, the training dataset including a plurality of training samples, each training sample of the plurality of training samples corresponding to a recycled asset; and
train a recovery value prediction module using the plurality of training samples to predict a recovery value of a provided asset.

10. The system of claim 9, wherein a training sample corresponding to a recycled asset includes one or more features correlated with the recovery value of the recycled asset.

11. The system of claim 9, wherein the recovery value prediction module includes a regression-based model.

12. The system of claim 11, wherein the regression-based model includes a gradient boosting regression model.

13. The system of claim 11, wherein the regression-based model includes a dense neural network (DNN).

14. The system of claim 11, wherein execution of the instructions further causes the one or more processors to:
predict, using a trained recovery value prediction module, a recovery value of an old asset;
identify, using a machine learning (ML) model, one or more new products that most closely match the old asset; and
recommend the one or more new products with an offer to recycle the old asset for the predicted recovery value.

15. The system of claim 14, wherein the trained recovery value prediction module includes a k-nearest neighbor (k-NN) model.

16. The system of claim 15, wherein the one or more new products are identified using one of Euclidean distance or cosine similarity.

17. A computer implemented method to offer recovery of an old asset, the method comprising:
determining, using a first machine learning (ML) model, a predicted recovery value for an old asset;
identifying, using a second ML model, one or more new products that most closely match the old asset; and
recommending the one or more new products with an offer to recycle the old asset for the predicted recovery value.

18. The method of claim 17, wherein the first ML model is trained using a training dataset generated from historical recycling settlement data regarding a plurality of recycled assets.

19. The method of claim 17, wherein the first ML model includes a regression-based model.

20. The method of claim 17, wherein the second ML model is trained using a training dataset generated from information regarding configuration and pricing of a plurality of new products.
